(19) United States
(12) Patent Application Publication
(10) Pub. No.: US 2017/0331319 A1
(43) Pub. Date: Nov. 16, 2017

(54) CHARGING DEVICE AND METHOD FOR OPERATING A CHARGING DEVICE

(71) Applicant: NITZ ENGINEERING GMBH, Brixen (IT)

(72) Inventor: Rüdiger NITZ, Feldthurns (BZ) (IT)

(21) Appl. No.: 15/604,025

(22) Filed: May 24, 2017

Related U.S. Application Data
(63) Continuation of application No. PCT/EP2015/075268, filed on Oct. 30, 2015.

(30) Foreign Application Priority Data
Nov. 24, 2014 (DE) 10 2014 117 180.2

(51) Int. Cl. H02J 7/02; H02J 7/04; H04B 1/3827; H02J 7/00; G06Q 20/14; G06Q 50/06

(52) U.S. Cl. CPC H02J 7/025; H04B 1/3827; H02J 7/027; H02J 7/041; G06Q 50/06; G06Q 20/145; H02J 2007/005; H02J 2007/0096; H02J 2007/0001

(57) ABSTRACT

A charging device is provided for charging a power storage unit of a mobile terminal, wherein the charging device comprises a power transmission device for transmitting electrical power to the mobile terminal, an electronic charger coupled to the power transmission module for controlling the power transmission, and a data transmission module coupled to the electronic charger for transmitting data between the charging device and the mobile terminal. A method and mobile terminal corresponding to the charging device are provided as well.

### CROSS REFERENCE TO RELATED APPLICATIONS

This application is a continuation of International Application No. PCT/EP2015/075268, filed on Oct. 30, 2015, which claims priority to German Application No. 10 2014 117 180.2, filed on Nov. 24, 2014, the contents of each of which are hereby incorporated by reference in their entirety.

### FIELD OF THE INVENTION

The invention relates to a charging device for charging an energy storage of a mobile terminal, as well as a method for operating a charging device according to the invention and a method for charging an energy storage of a charging device of a mobile terminal.

### BACKGROUND OF THE INVENTION

Charging devices for charging an energy storage of a mobile terminal, as a smartphone, are known in prior art. Such charging devices are plugged into a socket and are coupled to the terminal device to be charged. By this, the terminal device, in fact, can be charged. However, it is not possible to control the charging duration, as it would be desirable, for example, in public institutions or institutions open to public so as to enable other people access to the socket.

For example, a bar or a library may provide a number of such charging devices in order to enable guests to charge their cellular phones, tablets, or laptops. Monitoring of the individual charging processes or of the individual charging duration either is not possible or not feasible. Thereby, in the end, the provider of the charging devices is prevented from charging a time-dependent fee for a charging process.

Moreover, also wireless charging devices for mobile terminals are known in prior art. Here, the mobile terminal only has to be placed close to the charging device in order to initiate the charging process. However, the provision of such wireless charging devices entails the same problems as the provision of wired charging devices. Also here, it is not feasible to monitor the individual charging times such that a time-dependent fee cannot be charged for a charging process.

Charging a charging fee on a flat rate basis independent of the charging duration neither is feasible, because this would privilege longer charging durations compared to shorter charging durations.

### OBJECT OF THE INVENTION

Therefore, it is an object of the present invention to provide solutions which at least partially avoid the disadvantages known from prior art.

### Solution According to the Invention

According to the present invention, this object is solved by a charging device, by a method for charging a mobile terminal, by a mobile terminal, as well as by a computer program product according to the independent claims. Preferred embodiments and further developments of the invention are specified in the respective dependent claims.

Accordingly, a charging device for charging an energy storage of a mobile terminal is provided, wherein the charging device comprises
an energy transmission means for transmission of electrical energy to the mobile terminal,
charging electronics coupled to the energy transmission means for controlling the energy transmission, and
a data transmission module coupled to the charging electronics for transmission of data between the charging device and the mobile terminal.

The charging device may be adapted to transmit a unique identifier of the charging device, preferably, via the data transmission module, to the mobile terminal. The mobile terminal may then, depending on the identification of the charging device, control the charging process.

Hereby, it is preferable that, for example, the duration of the energy transmission may be controlled by means of the charging electronics. The mobile terminal may, by means of the data transmitted between the charging device and the mobile terminal, transmit data to the charging device which may be made available for controlling the energy transmission of the charging electronics. Thus, the mobile terminal is able, for example, to notify a charging duration to the charging device. Alternatively, the mobile terminal of the charging means may signalize the start and the end of the charging process, in particular, depending on the unique identifier of the charging device.

The charging device may be adapted to receive a charging indicator, preferably, via the data transmission module of the mobile terminal wherein the charging indicator indicates whether the energy storage of the mobile terminal is charged. Moreover, the charging device may be adapted to terminate the transmission of electrical energy to the mobile terminal, if the charging indicator indicates that the energy storage of the mobile terminal is not being charged. Thereby, the charging device may be prevented from providing electrical energy for charging another mobile terminal, if the currently charged terminal is removed from the charging device.

However, it is preferable, if the charging indicator indicates that the energy storage of the mobile terminal is charged as long as a predetermined content, in particular, advertisements are being displayed at the mobile terminal. If the predetermined content is no longer displayed at the mobile terminal, the mobile terminal may inform the charging device that the charging device no longer has to or should provide electrical energy for charging the mobile terminal. Thereby, the charging process may be made dependent on the data, as advertisements, displayed at the mobile terminal.

The charging device may be adapted to receive a unique identifier of the mobile terminal, preferably, via the data transmission module. The unique identifier of the mobile terminal may be transmitted together with the charging indicator. By means of the unique identifier of the mobile terminal and the unique identifier of the charging device, the mobile terminal and the charging device may run an initialization prior to the start of the charging process in which both identifiers are exchanged (handshake). During the charging procedure, the charging device may then check (in case the unique identifier of the mobile terminal is transmitted together with the charging indicator) whether e.g., the charging indicator is transmitted from an authorized terminal. Thereby, after the authorized terminal has been removed from the charging device, a further mobile terminal is prevented from being able to be charged, if the initialization has not been carried out previously for this further mobile terminal.

According to a preferred embodiment of the invention
the energy transmission means comprises a primary coil for inductive transmission of electrical energy to the mobile terminal,
the primary coil is coupled to the charging electronics for controlling the inductive energy transmission, and
the data transmission module is adapted for wireless transmission of data between the charging device and to the mobile terminal.

Hereby, it is advantageous that the charging of the energy storage of a mobile terminal as well as the data necessary for controlling the energy transmission may be transmitted wirelessly between the charging device and the mobile terminal.

According to a preferred embodiment of the invention
the charging electronics or the data transmission module comprises a clock, by means of which a duration of the energy transmission may be set, wherein the charging device is adapted to transmit electrical energy to the mobile terminal for the duration set, and wherein the information on the duration can be transmitted via the data transmission module from the mobile terminal to the charging device, and/or
the charging electronics or the data transmission module comprises a decryption module by means of which cryptographically encrypted data received from the data transmission module is decrypted.

Further, a method for charging an energy storage of a mobile terminal using a charging device according to the invention is provided, wherein
the mobile terminal receives a unique identifier of the charging device from the charging device via a data transmission module,
the mobile terminal displays predetermined data at a display means of the mobile terminal, and
the mobile terminal transmits an activation message (token) to the charging device via the data transmission module as soon as the predetermined data is displayed at the display means of the terminal, wherein the charging device, by means of the activation message, is instructed to transmit electrical energy from the charging device to the mobile terminal.

The charging of the energy storage of the mobile terminal, thereby, may be made dependent on whether the predetermined data is displayed at the mobile terminal. This data may comprise advertisements such that the proprietor of the charging means may offer, for example, charging of a terminal free of charge, and namely, on the condition that the advertisements are displayed at the terminal.

It is advantageous, if the data being displayed at a display means of the terminal is dependent on the received unique identifier of the charging device. Thereby, during a charging process, different data may be displayed at different charging devices.

It is advantageous, if
the mobile terminal transmits the unique identifier of the charging device received to a server system in order to initiate an approval process at the server system,
after a successful approval process, the mobile terminal receives the activation message from the server system.

The activation message may comprise the data to be displayed at the display means of the terminal.

Alternatively or additionally, the activation message may comprise information on the duration for which electrical energy is to be transmitted from the charging device to the mobile terminal, wherein the transmission of electrical energy from the charging device to the mobile terminal is activated for the duration indicated in the activation message.

Hereby, it is advantageous that the approval of a charging process is carried out by a server means which is coupled to the mobile terminal, wherein the mobile terminal may activate the charging process. Thereby, it is avoided that the charging device has to be equipped with a data transmission means in order to communicate with the server means. The constructive outlay of the charging device thus may be kept low. Moreover, the proprietor of the charging device will not be charged any telecommunications costs, as costs for mobile communication, because the communication with the server means is executed from the mobile terminal, for example, via the mobile Internet.

According to a preferred embodiment, the mobile terminal transmits a charging indicator to the charging device.

Hereby, the charging indicator may indicate whether the energy storage of the mobile terminal is being charged wherein the charging device terminates the transmission of electrical energy to the mobile terminal, if the charging indicator indicates that the energy storage of the mobile terminal is not or no longer charged. The charging process for a specific terminal may be terminated, for example, if this terminal is being moved away from the charging device. Thereby, it is prevented that another terminal, for example, a non-authorized terminal, can be charged.

Alternatively or additionally, the charging indicator may indicate whether the predetermined data is displayed at the display means of the mobile terminal, wherein the charging means terminates the transmission of electrical energy to the mobile terminal, if the charging indicator indicates that the predetermined data is not or no longer displayed. Thereby, the charging process may be maintained at maximum as long as the predetermined data, for example, an advertisement, is being displayed at the mobile terminal.

Hereby, it is advantageous, if the charging indicator is transmitted together with the unique identifier of the charging device and/or together with a unique identifier of the mobile terminal. Thereby, it may be determined whether the charging indicator of an authorized terminal is transmitted to the charging device.

According to a preferred embodiment of the method according to the invention, the approval process comprises a payment process, by means of which the duration of the transmission of electrical energy from the charging device to the mobile terminal is billed, wherein the duration to be billed
is transmitted from the mobile terminal to the server system, or
is assigned to the unique identifier of the charging device, or
is determined from a payment amount which is transmitted from the mobile terminal to the server system.

It is advantageous, if the approval process comprises a step, in which the activation message is generated and transmitted to the mobile terminal, wherein the activation message comprises the duration
transmitted to the server system, or
assigned to the unique identifier, or
determined from the payment amount.

The activation message may comprise a unique identifier of the charging device. Thereby, for example, it is prevented that another charging device can be activated for the energy transmission by means of an activation message.

According to an embodiment of the invention, the activation message may be encrypted cryptographically. Preferably, the cryptographic keys for encrypting and for decrypting the activation message are only known to the server means or the charging device, wherein according to an even further preferred embodiment of the invention, a different pair of keys may be assigned to each charging device such that a cryptographically encrypted activation message, in fact, only may be decrypted by that charging device which the activation message is intended for.

The activation of the transmission of electrical energy from the charging device to the mobile terminal, and in particular, for the duration indicated in the activation message, may comprise:
the activation message is transmitted from the mobile terminal to the charging device via the data transmission module,
the clock (timer) is initialized in the charging device according to the duration indicated in the activation message,
the transmission of electrical energy from the charging device to the mobile terminal is started, and
after expiration of the duration, the transmission of the electrical energy is terminated.

The duration of the energy transmission is controlled by the timer. If, for example, the timer reaches a value corresponding to the duration indicated in the activation message, the energy transmission may be terminated.

It is advantageous, if the charging device may decrypt the transmitted activation message such that cryptographically encrypted activation messages may be used.

According to a preferred embodiment of the method according to the invention
the unique identifier and/or the activation message is/are transmitted between the charging device and the mobile terminal wirelessly, and/or
the electrical energy is transmitted from the charging device to the mobile terminal inductively.

According to an embodiment of the method according to the invention, in addition to a unique identifier of the charging device, also a unique identifier of the mobile terminal may be transmitted to the server system. This unique identifier of the mobile terminal may be, for example, the mobile phone number of the mobile terminal. Thereby, a charging process may be billed, for example, via the mobile phone bill of the proprietor of the mobile terminal. Of course, a charging process may also be executed via other payment methods, as via PayPal, credit card, or In-App-Purchases. This may be advantageous, if the proprietor of the mobile terminal wants to continue the charging process, after the predetermined data, as an advertisement, is no longer displayed at the mobile terminal.

Further, a mobile terminal is provided by the invention, which is adapted to charge its energy storage, in particular, an accumulator, according to the method according to the invention.

It is advantageous, if the mobile terminal comprises a secondary coil of an inductive energy transmission means and a data transmission module for wireless data transmission between the mobile terminal and a charging device, in particular, a charging device according to the invention.

The energy transmission between the mobile terminal and the charging device may be executed according to the so-called QI standard (inductive energy transmission). The data transmission modules of the mobile terminal and the charging device may comprise NFC data transmission modules, Bluetooth data transmission modules, WLAN data transmission modules, or other transmission modules suitable for short-range data transmission.

Further, a computer program product is provided, in particular, a mobile application, which may be loaded into the internal storage of a terminal, in particular, mobile terminal, and which comprises program sections, by means of which the method according to the invention is executed when the computer program product is executed on the terminal.

The computer program product may, for example, comprise a so-called App, which may be loaded via a mobile communications network from a server means onto the mobile terminal and which may be executed there.

According to a further aspect of the invention, a furniture board is provided having a recess or a through hole wherein the charging device according to the invention may be or is arranged within the recess or within the through wall. Thereby, pieces of furniture, for example desktops, bar tables, or the like may be provided which enable charging of an energy storage of a mobile terminal by means of an integrated charging device or by means of an integratable charging device.

### BRIEF DESCRIPTION OF THE FIGURES

Details and features, in particular, preferred embodiments and further developments of the invention can be derived from the following description in connection with the drawing, in which:

FIG. 1 shows a charging device according to the invention with a mobile terminal being arranged relative to the charging device;

FIG. 2 shows an alternative embodiment of a charging means according to the invention;

FIG. 3 shows a system overview with a charging device according to the invention, a mobile terminal according to the invention, and a server means for illustration of the method of charging an energy storage of the mobile terminal according to the invention;

FIG. 4 shows a first variant of the method according to the invention;

FIG. 5 shows a second variant of the method according to the invention;

FIG. 6 shows a method in which the charging device according to the invention and the mobile terminal according to the invention are used for handling a product order;

FIG. 7 shows a flowchart of a method for updating a database within the method for charging an energy storage of a mobile terminal according to the invention;

FIG. 8 shows a flowchart of a method for clearing a database which is used in a method for charging an energy storage of a mobile terminal according to the invention;

FIG. 9 shows a flowchart of the method according to FIG. 4; and

FIG. 10 shows a further variant of the method according to the invention.

### DETAILED DESCRIPTION OF THE INVENTION

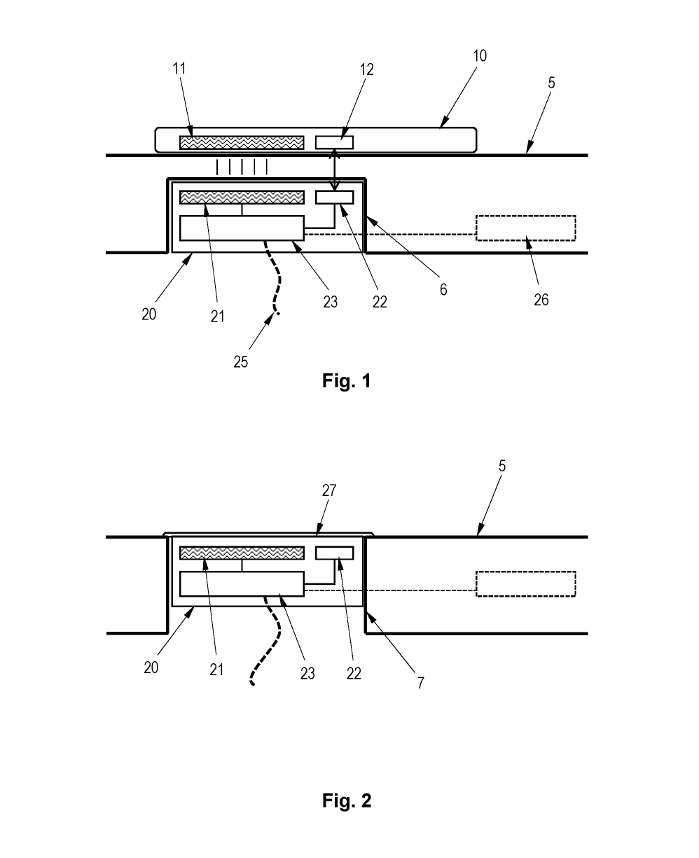

FIG. 1 shows a charging device according to the invention and a mobile terminal according to the invention arranged at the charging device.

The charging device 20, here, is arranged within a recess 6 of a furniture board 5 wherein the recess 6 is provided at the lower side of the furniture board 5. Preferably, the recess is dimensioned such that the charging device 20 is arranged in the recess 6 in a substantially form-fitting manner, and may be fastened there. According to a particularly preferred embodiment, the charging device 20 comprises a cylindrically shaped housing such that the recess 6 may be created in a particularly simple manner by means of a cylindrically shaped boring.

The charging device 20 comprises an energy transmission means which here is configured as primary coil 21 of an inductive energy transmission means. Further, the charging device 20 comprises charging electronics 23 by means of which the energy transmission, in particular, the inductive energy transmission may be controlled. Further, the charging device 20 comprises a data transmission module 22 by means of which a data exchange between the charging device 20 and a mobile terminal may be executed.

For controlling the energy transmission, the charging electronics 23 is coupled to the primary coil 21. Further, the charging electronics 23 is coupled to the data transmission module 22 such that data being received by the data transmission module 22 may be provided to the charging electronics 23. By means of this data, the charging electronics 23 may be instructed, for example, to execute a charging process according to a particular procedure. For example, the data may comprise information on how long a charging process is allowed to last for a particular terminal.

According to a preferred embodiment, the data transmission module 22 is configured as NFC module (Near Field Communication). However, also other short-range data transmission modules or data transmission protocols may be used.

The charging device 20 further comprises an energy supply cable 25, by means of which the charging device 20 may be connected to an energy supply. Alternatively, also an own energy supply, for example, an accumulator, may be integrated into the charging device 20.

According to an even further alternative embodiment of the invention, an energy supply module 26, for example, an accumulator, may be integrated into the furniture board 5 which may be coupled to the charging device 20. Preferably, the energy supply module 26 is arranged at or within the furniture board releasably such that the energy supply module may be exchanged, if needed, in a simple and fast manner.

The mobile terminal 10 according to the invention comprises a secondary coil 11 of an inductive energy transmission means. With corresponding arrangement of the mobile terminal 10 relative to the charging device 20, an energy transmission may be carried out between the primary coil 21 of the charging device 20 and the secondary coil 11 of the mobile terminal.

Further, the mobile terminal 10 comprises a data transmission module 12 which is configured as NFC module in the embodiment shown in FIG. 1. The mobile terminal 10 may transmit data to the charging device 20 or receive data from the charging device 20 via the data transmission module 12. For example, the mobile terminal 10 may transmit data to the charging device 20 comprising information on how long its charging process is to last.

Several different data transmission modules 22 may be provided in the charging device 20 such that mobile terminals with different data transmission modules 12 may be charged according to the charging process according to the invention.

In FIG. 1, a system is shown according to which the energy transmission from the charging device 20 to the mobile terminal 10 is carried out on an inductive basis according to the QI standard, and according to which the data exchange between the charging device 20 and the mobile terminal 10 is performed wirelessly. According to an alternative embodiment of the invention, the energy transmission, however, may also be wire-based, and the data exchange may be carried out wirelessly. According to still a further alternative embodiment of the invention, the energy transmission as well as the data exchange may be carried out in a wire-based manner.

The system according to the invention has the advantage that an energy transmission for charging of an energy storage of the mobile terminal is started only, if the mobile terminal 10 provides corresponding data to the charging device 20 via the data transmission modules 12, 22 which has to be evaluated by the charging device 20 successfully.

Thus, the mobile terminal 10 may provide, for example, data to the charging device 20 comprising information on how long the charging process may last. Moreover, the mobile terminal 10 may transmit data to the charging device comprising a unique identifier of the charging device such that the charging device starts and energy transmission only, if the transmitted unique identifier corresponds to the unique identifier of the charging device. Thereby, for example, it may be ensured that a mobile terminal may only be charged at certain charging devices.

Alternatively or additionally, the mobile terminal 10 may also transmit a unique identifier of the mobile terminal to the charging device 20. The charging device 20 then may be configured such that it only starts and energy transmission, if the received unique identifier of the mobile terminal 10 meets one or certain predetermined criteria. Hereby, one criterion may be that the unique identifier of the mobile terminal received has to be stored in a storage means of the charging device 20. In case the unique identifier of the mobile terminal received is not stored in the storage means, an energy transmission may be prevented. Thereby, for example, it may be provided for only certain selected mobile terminals are being allowed to be charged at a certain charging device.

The storing of a unique identifier of a mobile terminal 10 in a storage means of the charging device 20 may be, according to an alternative embodiment of the invention, also provided for continuing a charging process after an interruption of the charging process. In case the proprietor of a mobile terminal has, for example, bought one hour charging time and the charging process is interrupted prior to the expiry of the charging time bought, the charging process may be continued at a later point of time such that an available credit of charging time will not be lost. The charging device 20, for this, stores the unique identifier of the mobile terminal together with the remaining charging time. However, this requires that the charging process for this mobile terminal is continued at the same charging device.

According to an alternative embodiment of the charging method according to the invention, it may be provided for the charging process also being able to be continued at another charging device, for example, at a different charging device belonging to a group of charging devices which also the charging device belongs to, at which the charging process has been started initially. For this, it is advantageous, if the remaining charging time is stored in the mobile terminal together with an identifier identifying a group of charging devices, or alternatively is stored on a server means coupled to the mobile terminal. Then, prior to restarting the charging process, the charging device 20 only has to verify an identifier identifying a group of charging devices, and upon successful verification, resume the charging process for the remaining charging duration again. The mobile terminal 10 only has to provide this one identifier identifying this one group of charging devices device 20 and the remaining charging time to the other charging via the data transmission modules 12, 22.

FIG. 2 shows an alternative embodiment of a charging device 20 according to the invention. The charging device 20, here, is arranged within a through hole 7 of a furniture board 5 such that the charging device 20 is visible at the top side of the furniture board 5. In the embodiment shown here, the charging device 20 comprises a cover plate 27 having a slightly larger diameter than the through hole 7. Further details of the configuration and functionality of the charging device 20 shown in FIG. 2 correspond to the configuration and functionality of the charging device 20 described with reference to FIG. 1.

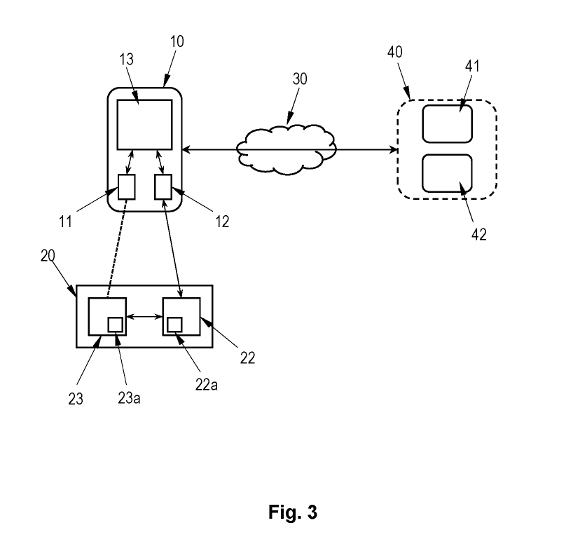

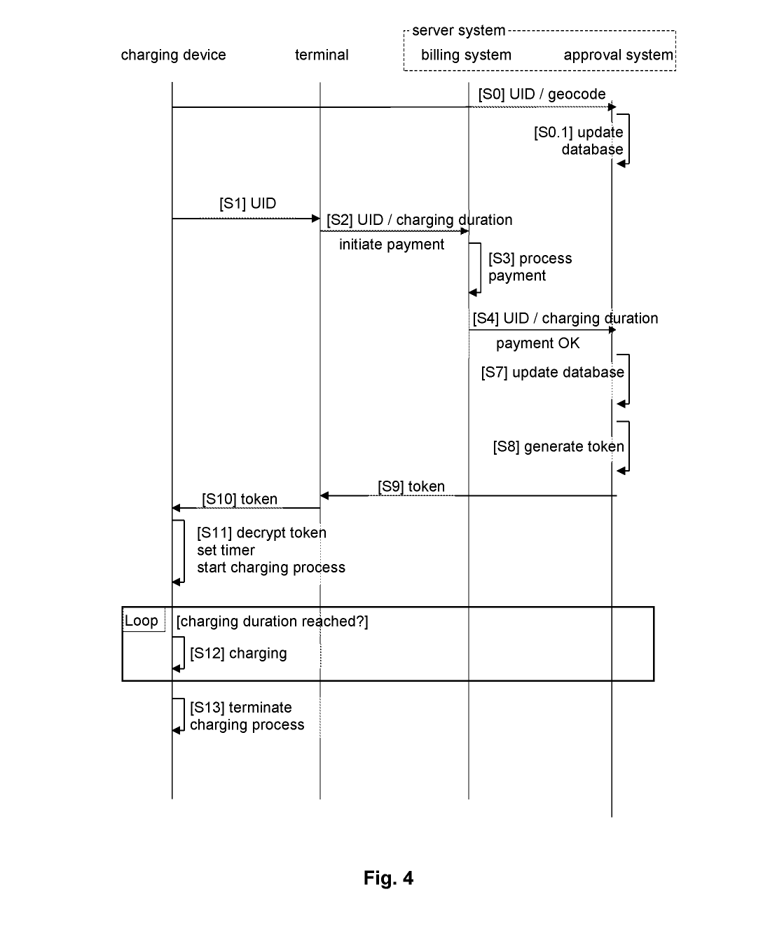

FIG. 3 shows a system overview with a mobile terminal 10 according to the invention, a charging device 20 according to the invention, and a server system 40.

The mobile terminal 10 may be coupled or is coupled to the server system 40 via a communications network 30, as the mobile Internet. The server system 40, with respect to the embodiment shown in FIG. 3, comprises a billing system 41 and an approval system 42 which may be provided by a physical server or which may be embodied by two different servers coupled via a communications network.

The mobile terminal 10 which may be, for example, a smart phone, a tablet computer, a notebook, or another mobile terminal, comprises a secondary coil 11 of an inductive charging device and a data transmission module 12. The data transmission module may be, for example, adapted for wireless data transmission. Preferably, the data transmission module 12 is an NFC module, a Bluetooth module, in particular, a BLE module (Bluetooth-Low-Energy), or a WLAN module.

Further, the mobile terminal 10 comprises an application program 13 being stored in a memory of the mobile terminal 10, and being executable on the mobile terminal. The application program 13 may be configured as so called App. Further, the application program 13 is adapted to communicate with the data transmission module 12 or to control the data transmission module 12. The application program 13 may receive data or send data via the data transmission module 12, in particular, to the charging device 20.

Further, the mobile terminal 10 comprises a communication interface in order to establish a data connection to the server system 40. The communication interface may be, for example, a mobile communications interface. Alternatively, the communication interface may also be configured as WLAN interface. The mobile terminal 10 may transmit data to the server system 40 and receive data from the server system 40 via the communication interface.

In FIG. 3, the charging electronics 23 and the data transmission module 22 of the charging device 20 are shown. The primary coil of the charging device 20 being coupled to the charging electronics 23 is not shown in FIG. 3.

The data transmission module 22, here, may be configured as wireless data transmission module. Preferably, the data transmission module 22 is an NFC module, a Bluetooth module, a BLE module and/or a WLAN module. The provision of different data transmission modules 22 has the advantage that mobile terminals 10 having different data transmission modules 12 may communicate with the charging device 20.

The energy transmission is carried out between the primary coil 21 of the charging device 20 not shown in FIG. 3 and the secondary coil 11 of the mobile terminal 10. The data transmission is carried out between the data transmission module 12 of the mobile terminal and the data transmission module 22 of the charging device 20. The energy transmission as well as the data transmission is carried out wirelessly.

According to an alternative embodiment of the invention, the energy transmission may also be wire-based and the data transmission may be wirelessly. According to still a further alternative of the invention, the energy transmission as well as the data transmission may be carried out in a wire-based manner.

The charging electronics 23 further comprises a timer 23a by means of which a maximum charging duration or a remaining charging duration may be controlled. That means, the timer 23a prescribes to the charging electronics 23 how long a charging process may last altogether. The clock or timer 23a may be implemented as hardware as well as software within the charging electronics 23.

The data transmission module 22 of the charging device 20, moreover, may comprise a decryption module 22a by means of which encrypted data received by the mobile terminal 10 may be decrypted. Moreover, also an encryption module may be provided in order to encrypt data to be transmitted to the terminal 10. According to a preferred embodiment of the invention, however, it is provided that the decryption module 22a and, if needed, an encryption module are integrated into the charging electronics 23. Thereby, specific modifications of the data transmission module 22 are avoided such that standard data transmission modules may be used.

With respect to a charging process according to the invention, the mobile terminal 10 is arranged relative to the charging device 20 such that the secondary coil 11 of the terminal 10 is located relative to the primary coil 21 of the charging device 20 such that between both coils, an inductive energy transmission may be performed. With such an arrangement of the two coils relative to each other, it is also ensured that a data transmission may be carried out between the two data transmission modules 12, 22.

According to the invention, it is provided for an energy transmission for charging an energy storage of the terminal 10 only being started, if the energy transmission is approved.

For the approval of the energy transmission, it is provided for the mobile terminal 10 requesting such an approval from the server system 40. The requesting of the approval and the subsequent approval of the energy transmission is carried out by means of the application program 13 of the mobile terminal 10. After starting the application program 13, the user of the mobile terminal 10 may request a charging process by means of a user input in the application program 13. After such a request, at first, a unique identifier of the charging device 20 is transmitted from the charging device 20 to the mobile terminal 10 via the data transmission modules 12, 22. The mobile terminal 10 transmits this unique identifier to the server system 40. Additionally, the mobile terminal 10 may also transmit information on a desired charging duration to the server system 40. The server system 40 processes the unique identifier received and, if needed, the information on a desired charging duration, and from this, generates an activation message (token) which is transmitted to the mobile terminal 10 via the communications network 30. This request message comprises data by means of which the charging process may be approved or started. It is preferable, if the request message comprises information on a maximum charging duration of the charging process. Further, it is preferable, if the request message moreover comprises a unique identifier of the charging device 20. Thereby, it is ensured that the request messages may only be used for the charging device identified by the unique identifier in order to approve the charging process. It is particularly preferable, if the request message is encrypted cryptographically.

After receipt of the request message, the latter is processed by the application program 13 of the mobile terminal 10, if needed, and is transmitted to the charging device 20 subsequently. The charging device 20 may decrypt the request message, if needed, (by means of the decryption module 22a) as far as the request message has been transmitted in an encrypted manner. From the possibly decrypted request message, the charging device 20 may deduce information on the maximum charging duration of the charging process, and thereby, may set or initialize the timer 23a. Subsequently, the inductive charging process may be started, whereby the charging process is limited to the charging duration indicated in the request message. After expiration of the charging duration or after expiration of the timer 23a, the charging process is terminated automatically.

Prior to starting the charging process, the charging device 20, moreover, may verify whether a unique identifier indicated in the request message corresponds to the unique identifier of the charging device. In case these two identifiers do not match, the charging device 20 may deny starting of the energy transmission.

As explained above, the system may be adapted to continue a discontinued charging process at the same charging device 20, or at another charging device 20. For this, it may be preferable, if several charging devices belonging together (for example, all charging devices in a bar or all charging devices in a library) may be additionally identified by means of a further unique identifier (group identifier). By means of the group identifier which is transmitted to the charging device, the charging device may then determine whether the unique identifier of the charging device 20 indicated in the request message belongs to a group of charging devices.

Alternatively, the group affiliation may also be verified by storing all unique identifiers of charging devices belonging to a group of charging devices by the charging device 20.

Alternatively, this group information may also be stored in the server system 40. For the resumption of the charging process, it is provided for the mobile terminal 10, in turn, transmitting a request message to the charging device 20, wherein the still remaining charging time is indicated in the request message instead of the maximum charging duration. The still remaining charging time may, for example, be stored in the mobile terminal. Alternatively, the still remaining charging time may be stored together with the unique identifier of the charging device 20 or together with the unique group identifier in the server system 40. The remaining charging duration may be determined after an interruption of the charging process by the mobile terminal or by the application program 13 by, for example, monitoring the charging process by the application program 13. Due to the monitoring of the charging process, the mobile terminal may determine the already elapsed charging duration. The maximum charging duration minus the already elapsed charging duration determined then amounts to the still remaining charging duration for a resumed charging process.

The resumption of a charging process for the still remaining charging duration has the advantage that upon purchasing a certain charging duration, the still remaining charging duration does not expire after an interruption of the charging process.

It is noted that the charging devices belonging to a group do not necessarily have to be located close to each other geographically. For example, an airline may consolidate all charging devices provided in business lounges at different airports in one group of charging devices such that a charging process may be started at one airport and may be continued at another airport.

The server system 40 comprises a billing system 41 and an approval system 42. After receipt of the unique identifier and, if needed, of the maximum charging duration desired, the billing system 41 may collect a fee for the charging process from the owner of the mobile terminal 10. This may be performed, for example, by means of a credit card deposited in the system, via PayPal, via direct debit, or via a so-called In-App-Purchase. After successful payment, the information on the successful payment and, if needed, a corresponding charging duration may be transferred to the approval system 42 which generates the request message described above, and transmits it to the mobile terminal 10.

The server system 40, moreover, may store the unique identifier received together with date and time of the receipt in a database, or may update the date and the time for a unique identifier already stored in the database. By means of a thus updated database of unique identifiers, for example, it may be determined by means of heuristics whether certain charging devices are still used actively. In case the last use of a charging device 24 for a charging process has been more than three months ago, it can be assumed that the charging device no longer exists. This charging device and the corresponding unique identifier may then be removed from the database.

It is advantageous, if also a geographical location of the corresponding charging device 20 is stored together with the unique identifier. The geographical location of the charging device 20 may be transmitted together with the unique identifier to the server system 40. Thereby, it is possible to create, for example, a map in which the geographical positions of the available charging devices are indicated. Together with the group identifier, it is also possible to indicate all charging devices belonging to a group of charging devices in the map.

The geographical location may be provided, for example, by a GPS module of the mobile terminal. For example, the mobile terminal may transmit the geographical location together with the unique identifier of the charging device.

FIG. 4 shows a first embodiment of a method for charging an energy storage of a mobile terminal according to the invention.

In a step S1, a unique identifier UID of the charging device is transmitted to the terminal.

In the subsequent step S2, the unique identifier UID received is transmitted to the server system or to the billing system. Also, a desired charging time and/or a unique identifier of the mobile terminal may be transmitted to the billing system together with the unique identifier UID. The unique identifier of the mobile terminal may, for example, be the mobile phone number. With transmission of the data, the payment or a payment process is initiated at the server system in the step S2.

After receipt of the data transmitted in the step S2, the payment is carried out in the step S3. For example, a monetary value may be calculated for the desired charging time which is collected from the account of the owner of the terminal. Alternatively, the monetary value may be debited to a credit card. According to still a further alternative, the monetary value may be paid within the scope of a so-called In-App-Purchase. Upon transmission of the mobile phone number of the mobile terminal, the billing may also be performed via the mobile phone invoice from the mobile phone provider.

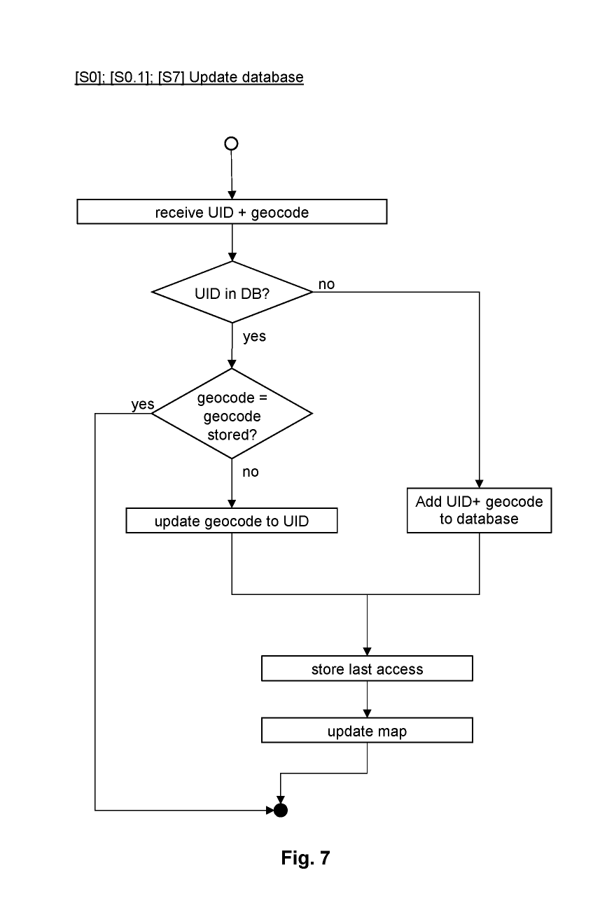

After successful processing of the payment, the approval of the charging process may be started. For this, in a step S4, the unique identifier of the charging device and the charging duration paid are transmitted to the approval system according to the method shown in FIG. 4. The approval system may optionally update the database in a step S7, as will be described in further detail with reference to FIG. 7. Further, the approval system generates an activation message (token) and sends the latter in the step S9 to the mobile terminal. The activation message generated in the step S8 at least comprises the charging time paid.

Instead of the desired charging duration, also information on an amount of money may be transmitted to the billing system in the step S2 which may then collect this payment amount correspondingly. The billing system and/or the approval system may then determine a corresponding charging duration for the amount of money paid which is then inserted into the activation message.

The user of the terminal may thus decide whether he books a certain charging duration under indication of the charging duration or under indication of an amount of money.

The activation message generated by the approval system may be encrypted prior to transmission to the terminal.

After receipt of the activation message, the terminal may transmit the latter to the charging device in the step S10.

In a subsequent step S11, the activation message may be decrypted, as far as the activation message has been transmitted in an encrypted manner. Further, in the step S11, the timer of the charging device is initiated, i.e., the charging duration indicated in the activation message is notified to the charging device or the charging electronics. Subsequently, the charging process may be started in the step S11.

Further, it is preferable, if also the unique identifier UID of the charging device is comprised in the activation message. Thereby, the charging device may determine whether the activation message is intended for it.

In the next step S12, the charging process is carried out wherein the charging process is maintained as long as the charging duration indicated in the activation message is reached. After reaching the charging duration, the charging process is terminated in the step S13.

According to the invention, it may be provided for the charging device being introduced to the server system or the approval system prior to the step S1. For this, the unique identifier UID and, if needed, the current geocode of the charging device may be introduced to the approval system in a step S0. The approval system may then update the database in the step S0.1, as is described in further detail with reference to FIG. 7.

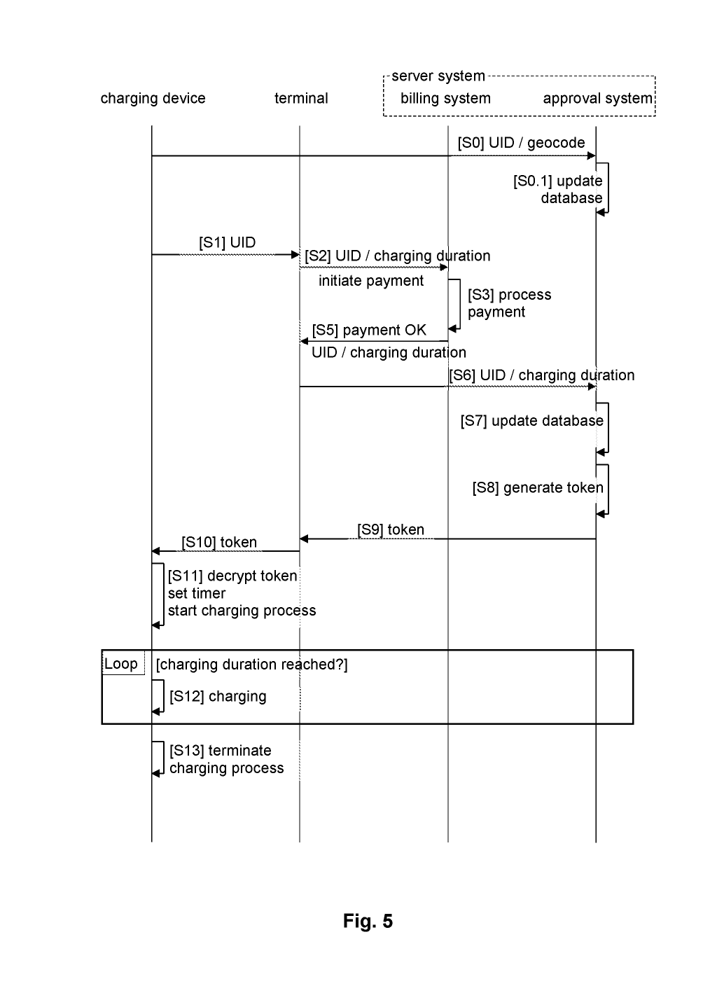

FIG. 5 shows a further embodiment of the method for charging an energy storage of the mobile terminal according to the invention. The steps S0 to S3 and S7 to S13 hereby correspond to the steps S0 to S3 or S7 to S13 of the method shown in FIG. 4.

With respect to the method shown in FIG. 5, subsequent to the step S3, the unique identifier UID of the charging device and the charging duration paid are transmitted from the server system or from the billing system to the terminal in a step S5. In a subsequent step S6, the terminal transmits the unique identifier UID and the information on the charging duration paid to the approval system which then, as is described with reference to FIG. 4, proceeds with the step S8 in the method.

The method described in FIG. 5 has the advantage that no communication takes place between the billing system and the approval system, facilitating the server sided implementation of the method.

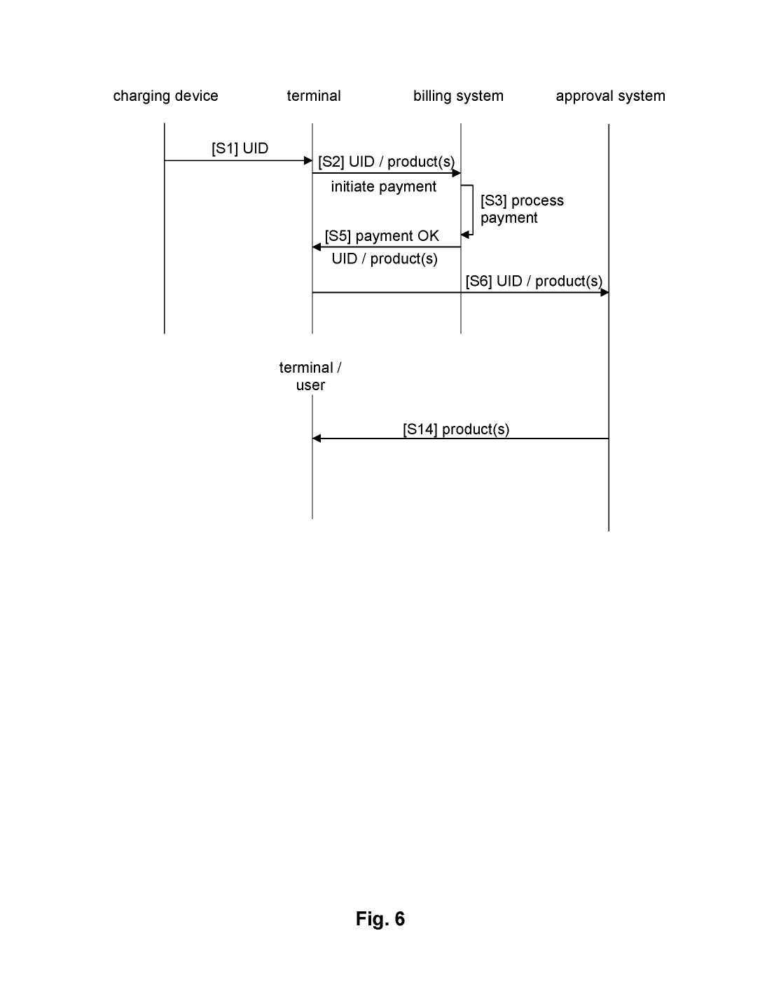

FIG. 6 shows a sequence diagram of a further method which can be carried out by means of a charging device according to the invention and a terminal according to the invention.

In a step S1, here, also a unique identifier UID of the charging device is transmitted to the mobile terminal. The charging device, hereby, may be a stationary charging device being integrated into a table of a restaurant. After the mobile terminal has been arranged at the charging device and the unique identifier UID has been transmitted to the terminal, the user of the terminal may select, at the terminal or in the application program 13, a number of products, as meals or beverages.

The information on the selected products and the unique identifier UID of the charging device may then be transmitted to a billing system where, in a step S3, the payment of the selected products is processed.

After successful payment, the unique identifier UID of the charging device and the information on the products paid are transmitted to the terminal in a step S5. Subsequent to this, the terminal transmits the unique identifier of the charging device and the information on the products paid to the approval system in a step S6. Alternatively, in the step S5, the unique identifier of the charging device and the information on the products paid may also be transmitted to the approval system directly such that the step S6 may be omitted.

Subsequently, in the step S14, the products are transmitted to the user of the terminal, i.e., the selected and paid meals and beverages are brought to the table into which the charging device with the unique identifier UID is integrated.

Different to the method shown in FIG. 4 and FIG. 5, in FIG. 6, the charging duration is not booked and paid but rather the products ordered and paid by means of the system according to the invention wherein due to the unique identifier UID of the charging device, the provider knows where to supply the products.

The method shown in FIG. 6 may also be used in order to, for example, pay a product to be purchased at an automatic vending machine, as a beverage dispenser. The mobile terminal according to the invention thereby is arranged relative to the automat such that a data transmission between the data transmission module of the automat and the data transmission module of the mobile terminal is possible. In the step S1, then the unique identifier UID of the automat is transmitted to the mobile terminal. The steps S2 to S5 are carried out according to the process sequence shown in FIG. 6.

Instead of the steps S6 and S14 shown in FIG. 6, and activation message is transmitted to the automat subsequent to the step S5. This activation message comprises information on which product(s) has/have been paid in the preceding steps. The automat evaluates the activation message and approves the products indicated in the activation message for being delivered. Hereby, it is advantageous that the automat itself does not require any communications connection to the billing system. By means of the unique identifier UID of the automat, the billing system may assign the payment made directly to the provider of the automat.

FIG. 7 shows a flowchart for the steps S0, S0.1, and S7 of the method shown in FIG. 4 and FIG. 5. At first, the server system or the approval system receives a unique identifier UID of the charging device and a geocode of the charging device. Subsequently, it is checked whether the unique identifier UID received is already stored in the database. As far as the unique identifier is not stored in the database, the unique identifier UID is added to the database together with the geocode. Otherwise, it is checked for the unique identifier UID whether the received geocode corresponds to the storage geocode.

In case the received geocode does not correspond to the stored geocode, the geocode is updated with respect to the unique identifier UID stored in the database. Otherwise, the update procedure terminates.

After addition of the unique identifier and the geocode to the database or after and updating of the geocode belonging to a unique identifier UID, or also for the case that the geocode corresponds to the geocode stored, the current access to the unique identifier UID is stored in the database, i.e., the date and the time of the current access to this unique identifier UID is stored. By means of this additional information, it may be checked whether unique identifiers for charging devices are stored in the database which have not been used over a certain time period.

In a last step, a map may be updated in which the locations of all charging devices stored in the database are displayed.

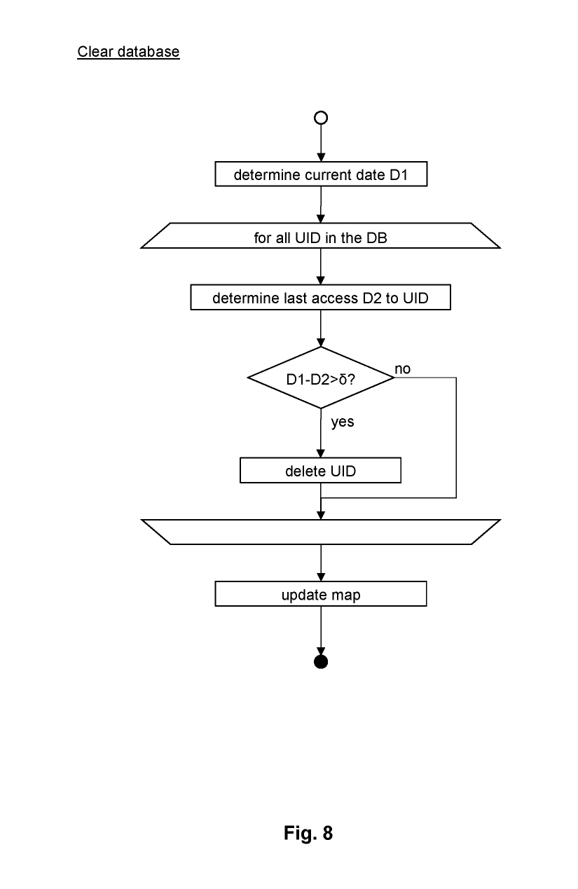

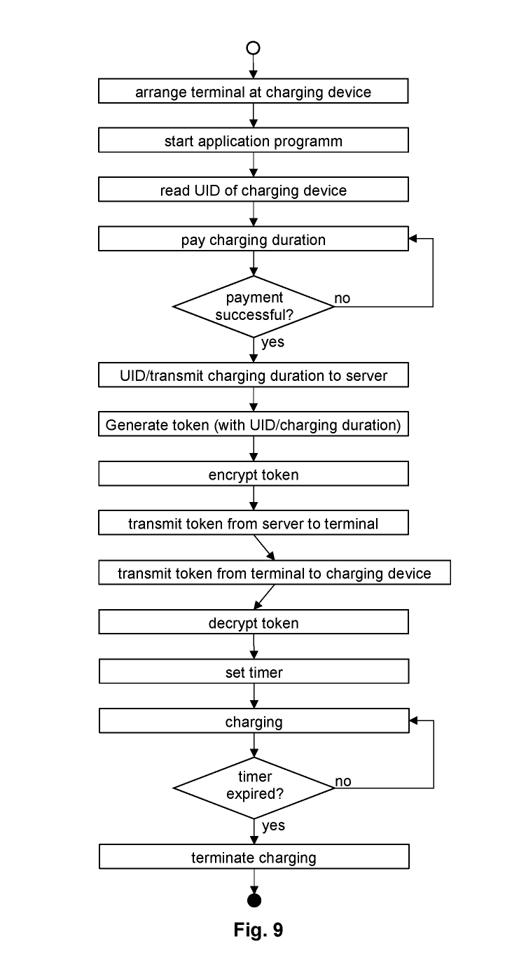

FIG. 8 shows a flowchart for clearing a database in which information on the charging devices is stored. This method may be carried out in regular intervals, for example, one time per month in order to remove, for example, information on presumably no longer existing charging devices from the database, and thereby from the map.

Initially, in a first step, the current date D1 is determined. For each charging device stored in the database, the last access D2 (i.e., the date of the last access) to the corresponding data set is determined. As far as the last access to the data set of the charging device is dated back for a predetermined duration δ, the data set for this charging device may be deleted. Otherwise, the data set remains within the database unchanged.

After this verification has been completed for all charging devices toward in the database, the map may, if needed, be updated.

FIG. 9 shows a flowchart of the method according to the invention. The process sequence itself substantially corresponds to the method shown in FIG. 4 and FIG. 5.

By means of the present invention, for example, a charging process for charging a mobile terminal at a charging device may be built without the charging device being required to establish a communications connection to the Internet, as via a mobile communications connection. It only is necessary that the charging device 20 comprises a short-range data transmission module 22 in order to establish a direct data connection to the mobile terminal. The constructive outlay of the charging device 20, thus, may be kept low. The invention, however, may also be realized with non-mobile terminals, as a stationary computer, or the like.

The system according to the invention may also be used for the operation of other facilities for which a certain time or duration may be purchased, for example, in order to use the facility for the duration purchased.

For example, for a vacuum cleaner device in a carwash, a certain use duration may be purchased. The terminal, hereby, receives the unique identifier of the vacuum cleaner device and transmits the unique identifier to the billing system and the use duration desired which the user may input into the application program of the terminal. The billing system transmits an activation message to the terminal comprising information on the use duration paid. The terminal transmits this activation message to the vacuum cleaner device which then retrieves the use duration from the activation message and activates the vacuum cleaner device for this use duration. After activation of the vacuum cleaner device, the mobile terminal may be removed from the vacuum cleaner device again. By transmission of the unique identifier UID, the billing system may directly assign the payment to the provider of the vacuum cleaner device. Moreover, it is avoided that the vacuum cleaner device has to be equipped with a cash box, reducing the risk of vandalism.

According to a further application example according to the invention, a certain money credit may be purchased. For example, a user of the terminal according to the invention may purchase a credit for a gaming machine. The unique identifier UID of the gaming machine is then admitted to the mobile terminal. The unique identifier is transmitted to the billing system together with the credit to be purchased. The payment system then carries out the payment and generates an activation message. The activation message then comprises information on the credit paid or purchased. The activation message is transmitted to the mobile terminal subsequently which in turn transmits the activation message to the gaming machine. The gaming machine extracts the purchased credit from the activation message, and provides this credit to the player for “gambling”.

The system may be used for the operation of various facilities according to the invention which require the purchase of use duration or the payment of a money amount for the operation.

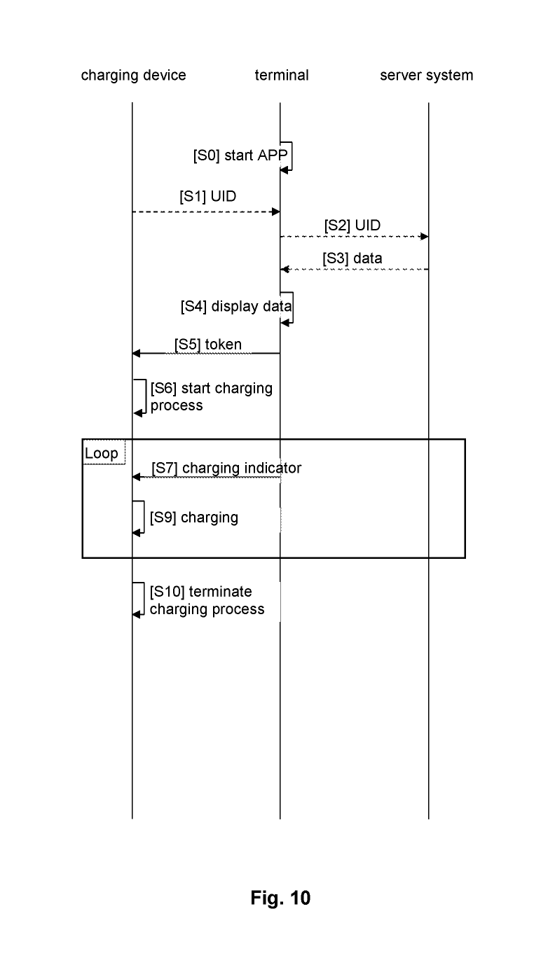

FIG. 10 shows a further variant of the method according to the invention according to which the use duration may not be purchased, or according to which the charging process has not to be paid, but rather is made dependent on the display of certain data at the mobile terminal during the charging process.

In a first step S0, the user of the terminal, as a smartphone, starts a software application, for example, an APP. The APP then establishes a communications connection to a charging device, for example, by means of Bluetooth or NFC. The terminal, via this communications connection, may make itself known to the charging device within the scope of an initialization.

In a further step S1, the charging device transmits a unique identifier UID of the charging device to the mobile terminal.

In the further optional steps S2 and S3, this unique identifier UID is transmitted to the server system, and from the server system, data is transmitted to the mobile terminal. The server system may select data on the basis of the unique identifier UID received which is to be transmitted to the terminal. The data may be assigned to the identifier UID on the server system. The content of the data to be transmitted, thereby, may be dependent on the charging device. For example, the data for this charging device may comprise advertisements, while for another charging device, it may comprise a menu.

In case the steps S2 and S3 are not executed, alternatively, the data may be provided by the APP itself or by the charging device. In case the data is provided by the APP, the APP may select certain data on the basis of the identifier UID transmitted. If the data is provided by the charging device, this data may be transmitted together with the identifier UID to the terminal.

The data thus provided to the terminal are being displayed at the terminal in the step S4. For example, in the APP mentioned above, the advertisement may be faded in.

As soon as the data is being displayed at the terminal, the mobile terminal or the APP instructs the charging device to start a charging process. The user of the terminal, hereby, brings the terminal sufficiently close to the charging device, if the charging device is adapted to carry out an energy transmission on an inductive basis. The terminal or the APP then, in the step S5, transmits a token or an activation message to the charging device by means of which the charging device is signalized that it may start the charging process, which eventually happens in the step S6.

During the charging process (Loop), the charging device verifies whether the charging process may be continued or should be continued. For this, the mobile terminal transmits a charging indicator to the charging device in the step S7.

According to an embodiment of the invention, the charging indicator indicates whether the energy storage of the mobile terminal is being charged. In this case, the charging is continued in the step S9. Otherwise, if also the energy storage of the mobile terminal is not or no longer being charged, the charging device terminates (step S10) the transmission of electrical energy to the mobile terminal. The terminal, for example, is not charged any longer, if the terminal is too far away from the charging device, or if the accumulator of the terminal is charged completely. Hereby, it is prevented that another terminal may continue the charging process.

The indication in the charging indicator whether the energy storage of the mobile terminal is being charged, when using a charging device operating on inductive basis has the advantage that no complicated distance measurements have to be carried out between the charging device and the terminal in order to ensure that in fact an authorized terminal is being charged.

According to an alternative embodiment of the invention, the charging indicator indicates whether the data (e.g., the advertisements) is displayed at the display means of the mobile terminal. If the data is no longer being displayed, the transmission of electrical energy to the mobile terminal is terminated. The data may, for example, no longer be displayed, if the APP in which the advertisements are displayed, has been terminated, or runs in the background such that the advertisements no longer are visible. Thereby, it is ensured that the charging process, in fact, is only continued as long as the data is being displayed at the terminal to be charged. If the data is not or no longer displayed, the charging device terminates the energy transmission in the step S10.

The charging indicator may transmit continuously or cyclically to the charging device. According to an embodiment, the charging device may request, if needed, the transmission of the charging indicator from the terminal.

It is advantageous, if the charging indicator is transmitted together with the unique identifier UID of the charging device and/or together with a unique identifier of the mobile terminal. If the unique identifier of the mobile terminal is transmitted together with the charging indicator, it may be ensured that only one authorized terminal is charged, if the terminal has to make itself known to the charging device within the scope of the initialization mentioned above.

### REFERENCE NUMERALS

5 furniture board
6 recess within the furniture board 5 (e.g., at the bottom side)
7 through hole in the furniture board 5
10 mobile terminal (e.g., smart phone)
11 secondary coil of the mobile terminal 10
12 data transmission module of the mobile terminal 10 (e.g. NFC module)
13 application program
20 charging device
21 primary coil of the charging device 20
22 data transmission module of the charging device 20 (e.g., NFC module)
22a decryption module
23 charging electronics
23a clock (timer)
25 power supply cable of the charging device 20
26 energy storage of the charging device 20 (e.g., accumulator)
27 cover plate of the charging device 20
30 communications network (e.g. mobile Internet)
40 server system
41 billing system
42 approval system
[S0] to [S14] method steps
UID unique identifier of the charging device (Unique Identifier)
DB database
δ time difference

1. A charging device (20) for charging an energy storage of a mobile terminal (10), wherein the charging device (20) comprises:
an energy transmission means for transmission of electrical energy to the mobile terminal (10);
charging electronics (23) coupled to the energy transmission means for controlling the energy transmission, and
a data transmission module (22) coupled to the charging electronics (23) for transmission of data between the charging device (20) and the mobile terminal (10),
wherein the charging device is adapted to transmit a unique identifier (UID) of the charging device (20), preferably, via the data transmission module, to the mobile terminal (10).

2. The charging device of claim 1, wherein the charging device is adapted to receive a charging indicator, preferably, via the data transmission module, from the mobile terminal (10), wherein the charging indicator indicates whether the energy storage of the mobile terminal is being charged, and wherein the charging device is adapted to terminate the transmission of electrical energy to the mobile terminal (10), if the charging indicator indicates that the energy storage of the mobile terminal is not being charged.

3. The charging device of claim 2, wherein the charging indicator indicates that the energy storage of the mobile terminal is being charged as long as a predetermined content, in particular, advertisements, are being displayed at the mobile terminal.

4. The charging device of claim 1, wherein the charging device is adapted to receive a unique identifier (MID) of the mobile terminal (10), preferably, via the data transmission module.

5. The charging device of claim 1, wherein
the energy transmission means comprises a primary coil (21) for inductive transmission of electrical energy to the mobile terminal (10),
the primary coil (21) is coupled to the charging electronics (23) for controlling the inductive energy transmission, and
the data transmission module (22) is adapted for wireless transmission of data between the charging device (20) and the mobile terminal (10).

6. The charging device of claim 1, wherein
the charging electronics (23) or the data transmission module (22) comprises a timer (23a) by means of which the energy transmission can be set, wherein the charging device (20) is adapted to transmit electrical energy to the mobile terminal (10) for the duration set, and wherein the information on the duration can be transmitted via the data transmission module (22) from the mobile terminal (10) to the charging device (20), and/or
the charging electronics (23) or the data transmission module (22) comprises a decryption module (22a) by means of which cryptographically encrypted data received from the data transmission module (22) can be decrypted.

7. A method for charging an energy storage of a mobile terminal (10) using a charging device (20) according to any one of the preceding claims, wherein
the mobile terminal (10) receives (S1) a unique identifier (UID) of the charging device (20) from the charging device via a data transmission module (12),
the mobile terminal (10) displays predetermined data at a display means of the terminal (10), and
the mobile terminal (10) transmits an activation message (token) to the charging device (20) via the data transmission module (12) as soon as predetermined data is displayed at the display means of the terminal (10), wherein, by the activation message, the charging device (20) is instructed to transmit electrical energy from the charging device (20) to the mobile terminal (10).

8. The method of claim 7, wherein the data displayed at a display means of the terminal (10) is dependent on the unique identifier of the charging device (20) received.

9. The method of claim 7, wherein
the mobile terminal (10) transmits (S2) the unique identifier (UID) of the charging device (20) received to a server system (40) in order to initiate an approval process at the server system, and
the mobile terminal (10) receives (S9) the activation message from the server system (40) after a successful approval process.

10. The method of claim 9, wherein the activation message comprises the data to be displayed at the display means of the terminal (10).

11. The method of claim 7, wherein the activation message comprises information on the duration for which electrical energy is to be transmitted from the charging device (20) to the mobile terminal (10), and wherein the transmission of electrical energy from the charging device (20) to the mobile terminal (10) is activated for the duration indicated in the activation message.

12. The method of claim 7, wherein the mobile terminal (10) transmits a charging indicator to the charging device (20).

13. The method of claim 12, wherein the charging indicator indicates whether the energy storage of the mobile terminal (10) is charged, and wherein the charging device terminates the transmission of electrical energy to the mobile terminal (10) if the charging indicator indicates that the energy storage of the mobile terminal is not or no longer charged.

14. The method of claim 12, wherein the charging indicator indicates whether the predetermined data is displayed at the display means of the mobile terminal (10), and wherein the charging device terminates the transmission of electrical energy to the mobile terminal (10), if the charging indicator indicates that the predetermined data is not or no longer displayed.

15. The method of claim 12, wherein the charging indicator is transmitted together with the unique identifier (UID) of the charging device (20) and/or together with a unique identifier (MID) of the mobile terminal (10).

16. The method of claim 9, wherein the approval process comprises a payment process (S3) by means of which the duration of the transmission of electrical energy from the charging device (20) to the mobile terminal (10) is built, wherein the duration to be billed
is transmitted from the mobile terminal (10) to the server system (40), or
the unique identifier (UID) is assigned to the charging device (20), or
is determined from a payment amount which is transmitted from the mobile terminal (10) to the server system (40).

17. The method of claim 16, wherein the approval process comprises a step (S8) in which the activation message is generated and transmitted (S9) to the mobile terminal (10), wherein the activation message comprises the duration
transmitted to the server system (40), or
assigned to the unique identifier (UID), or
determined from the payment amount.

18. The method of claim 7, wherein the activation message comprises the unique identifier (UID) of the charging device (20), and/or wherein the activation message is encrypted cryptographically.

19. The method of claim 7, wherein the activating of the transmission of electrical energy from the charging device (20) to the mobile terminal (10) comprises:
the activation message is transmitted (S10) from the mobile terminal (10) via the data transmission module (12) to the charging device (20),
a timer (23a) is initiated (S11) in the charging device (20) according to the duration indicated in the activation message,
the transmission (S12) of electrical energy from the charging device (20) to the mobile terminal (10) is started (S11), and
the transmission of electrical energy is terminated (S13) after expiration of the duration.

20. The method of claim 19, wherein the charging device (20) decrypts the activation message transmitted.

21. The method of claim 7, wherein
the unique identifier (UID) and/or the activation message are transmitted wirelessly between the charging device (20) and the mobile terminal (10), and/or
the electrical energy is transmitted inductively from the charging device (20) to the mobile terminal (10).

22. A mobile terminal (10) adapted to charge its energy storage according to the method of claim 7.

23. The mobile terminal of claim 22, comprising a secondary coil (11) of an inductive energy transmission means and a data transmission module (12) for wireless data transmission between the mobile terminal (10) and a charging device (20).

24. A mobile application which may be loaded into the internal memory of a mobile terminal, and which comprises program sections by means of which the method of claim 7 is executed, if the computer program product is being executed on the terminal.

25. A furniture board (5), comprising a recess (6) or a through hole (7), wherein a charging device (20) of claim 1 is arranged within the recess (6) or in the through hole (7).
